(19) United States
(12) Patent Application Publication
(10) Pub. No.: US 2025/0199200 A1
(43) Pub. Date: Jun. 19, 2025

(54) METALENS ASSEMBLY AND METHOD FOR MANUFACTURING THE SAME

(71) Applicant: TRIPLE WIN TECHNOLOGY (SHENZHEN) CO., LTD., Shenzhen (CN)

(72) Inventor: YI-MOU HUANG, New Taipei (TW)

(21) Appl. No.: 18/751,381

(22) Filed: Jun. 24, 2024

(30) Foreign Application Priority Data
Dec. 13, 2023 (CN) 202311720020.1

(51) Int. Cl. G02B 1/00; G02B 3/00

(52) U.S. Cl. CPC G02B 1/002; G02B 3/0018; G02B 2207/101

(57) ABSTRACT

A method for manufacturing a metasurface lens assembly, comprising the steps of: providing a substrate including a first region, a second region, and a third region connecting the first and second regions; etching the third region to form micron-sized support structures; etching the first region to form nanoscale metasurface lenses connected to the support structures; and removing the support structures to separate the metasurface lenses from the second region, resulting in a metasurface lens assembly. This method significantly enhances the structural strength of the metasurface microstructures, reducing damage during subsequent processing steps. Additionally, a metasurface lens assembly is provided.

### FIELD

The subject matter herein generally relates to metasurface lenses, and more particularly, to a metalens assembly and method for manufacturing the metalens assembly.

### BACKGROUND

Metasurface lenses (metalenses) operating in the far-infrared band (with a wavelength of 8 μm to 14 μm) are fabricated on substrates using precise micro-nano manufacturing techniques.

During the manufacturing process, the structural integrity of the metasurface microstructures, which are formed after inductively coupled plasma etching of silicon materials, may be poor. The poor structural integrity of the metasurface microstructures causes significant issues in subsequent processes like cutting and removal of protective support layers. For example, ultrasonic vibration cannot be used to remove of protective support layers.

Therefore, there is room for improvement in the art.

### BRIEF DESCRIPTION OF THE DRAWINGS

Implementations of the present technology will now be described, by way of example only, with reference to the attached figures.

FIG. 1 is a flowchart for manufacturing a metasurface lens assembly according to an embodiment of the present application.

FIG. 2 is a cross-sectional view of a substrate according to an embodiment of the present application.

FIG. 3 is a cross-sectional view showing a first photoresist being formed on the substrate in FIG. 2.

FIG. 4 is a cross-sectional view showing the substrate in FIG. 3 being etched to obtain a first intermediate structure.

FIG. 5 is a cross-sectional view showing a light-blocking pattern being formed on the first intermediate structure in FIG. 4.

FIG. 6 is a cross-sectional view showing a light-blocking layer being formed on the light-blocking pattern in FIG. 5.

FIG. 7 is a cross-sectional view showing the light-blocking pattern and portion of the light-blocking layer in FIG. 6 being removed to form a light-blocking element.

FIG. 8 is a cross-sectional view showing a second photoresist being formed on the light-blocking element in FIG. 7.

FIG. 9 is a cross-sectional view showing a first region in FIG. 7 being etched to form metasurface lenses.

FIG. 10 is a cross-sectional view showing the second photoresist in FIG. 9 being removed to obtain a second intermediate structure.

FIG. 11 is a cross-sectional view showing the metasurface lenses in FIG. 10 being separated from a second region to obtain a metasurface lens assembly.

### DETAILED DESCRIPTION

It will be appreciated that for simplicity and clarity of illustration, where appropriate, reference numerals have been repeated among the different figures to indicate corresponding or analogous members. In addition, numerous specific details are set forth in order to provide a thorough understanding of the embodiments described herein. However, it will be understood by those of ordinary skill in the art that the embodiments described herein can be practiced without these specific details. In other instances, methods, procedures, and members have not been described in detail so as not to obscure the related relevant feature being described. Also, the description is not to be considered as limiting the scope of the embodiments described herein. The drawings are not necessarily to scale and the proportions of certain portion may be exaggerated to better illustrate details and features of the present disclosure.

The term “comprising,” when utilized, means “including, but not necessarily limited to;” it specifically indicates open-ended inclusion or membership in the so-described combination, group, series, and the like.

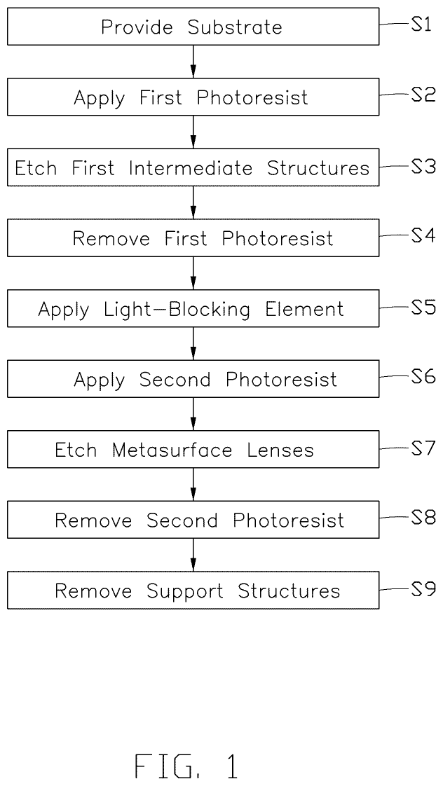

Referring to FIG. 1, an embodiment of the present application provides a method for manufacturing a metasurface lens assembly 100. The method is provided by way of example, as there are a variety of ways to carry out the method. Each block shown in FIG. 1 represents one or more processes, methods, or subroutines, carried out in the example method. Furthermore, the illustrated order of blocks is illustrative only and the order of the blocks can change. Additional blocks can be added, or fewer blocks may be utilized or the order of the blocks may be changed, without departing from this disclosure. The method can begin at block S1.

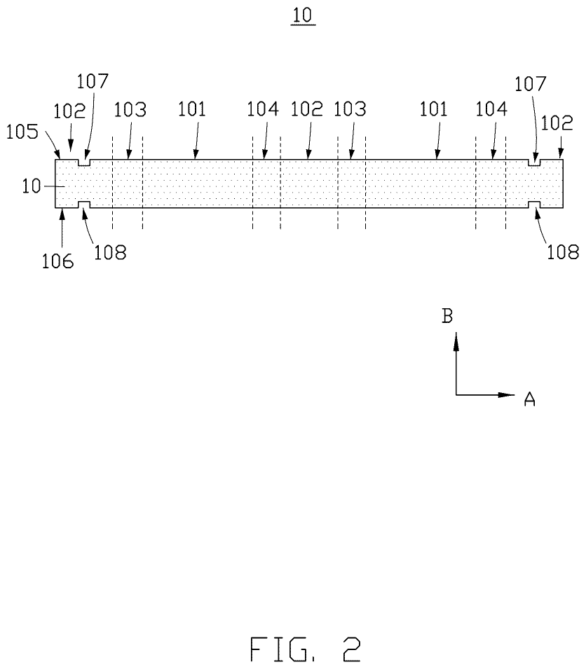

Block S1, referring to FIG. 2, a substrate 10 is provided. The substrate 10 has an extending direction A and a thickness direction B perpendicular to the extending direction A. Along the extending direction A, the substrate 10 is divided into a first region 101, a second region 102, a third region 103, and a fourth region 104. The second region 102 is substantially a frame structure. The first region 101 is located inside the second region 102. The third region 103 connects the first region 101 to one side of the second region 102. The fourth region 104 connects the first region 101 to the other side of the second region 102.

In this embodiment, along the thickness direction B, the substrate has a first surface 105 and a second surface 106. The first surface 105 and the second surface 106 are oppositely arranged. Each of two ends of the first surface define a first notch 107. Each of two ends of the second surface 106 defines a second notch 108. Each of the first notch 107 is correspondingly arranged with one of the second notch 108. The first notch 107 and the second notch 108 are used to provide positioning identification points, thereby facilitating subsequent operations.

In this embodiment, the substrate 10 is made of silicon. In other embodiments of the present application, the substrate 10 may be made of one of gold, silver, aluminum, or other metallic materials.

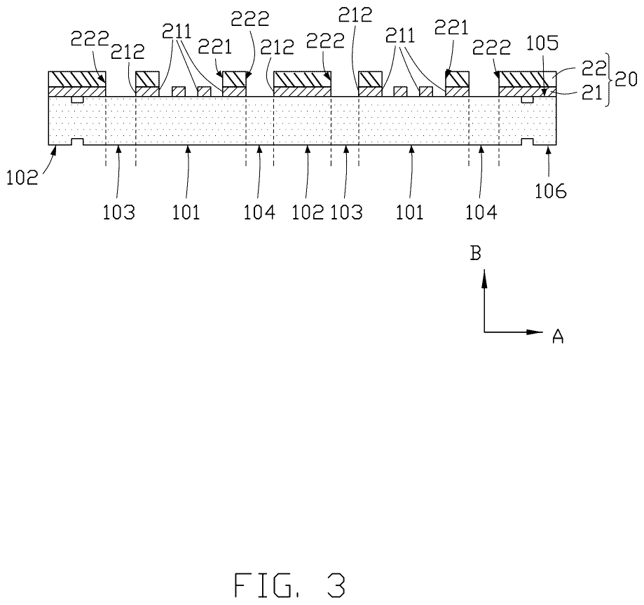

Block S2, referring to FIG. 3, a first photoresist 20 is disposed on the first surface 105 of the substrate 10. The first photoresist 20 includes a first photoresist layer 21 and a second photoresist layer 22. The first photoresist layer 21 is disposed between the second photoresist layer 22 and the first surface 105. The first photoresist 20 is a positive photoresist, which is soluble in a developer solution after exposure to light.

In this embodiment, the substrate 10 is pre-treated with a plasma cleaning process to improve the adhesion between the first photoresist layer 21 and the substrate 10, and enhance the precision of the following etching process.

Referring to FIG. 3, the first photoresist layer 21 defines multiple first openings 211 and multiple third openings 212. The multiple first openings 211 correspond to the first region 101, which exposing a portion of the first surface 105. The multiple third openings 212 correspond to the third region 103 and the fourth region 104, which exposing another portion of the first surface 105. A cross-sectional width of each of the first openings 211 is at the nanometer level, that is, a cross-sectional width of each of the first openings 211 is between 1 and 999 nanometers. A cross-sectional width of each of the third openings 212 is at the millimeter level, that is, a cross-sectional width of each of the third openings 212 is between 1 and 999 millimeters.

The second photosensitive layer 22 is defines multiple first holes 221 and multiple second holes 222. The first openings 211 correspond to and are connected to one of the first holes 221. The second holes 222 is arranged corresponding to the third region 103 or the fourth region 104. Each second holes 222 corresponds to and is connected to one of the third openings 212. A cross-sectional width of each of the first holes 221 is approximately three times a cross-sectional width of each of the first openings 211. A cross-sectional width of each of the second holes 222 is approximately the same as a cross-sectional width of each of the third openings 212.

In this embodiment, the first photosensitive layer 21 is formed through steps such as dry film, exposure development, and photo-etching. The second photosensitive layer 22 is formed by means of selective spray coating.

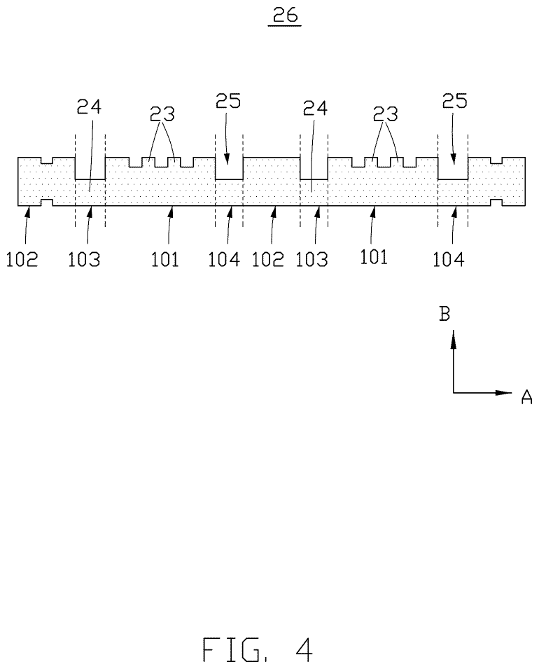

Block S3, referring to FIGS. 3 and 4, the exposed portion of the first region 101 is etched through the first openings 211 to form moth-eye structures 23. The exposed portion of the third region 103 is etched through the third openings 212 to form multiple support structures 24. The exposed portion of the fourth region 104 is etched through the third openings 212 to form multiple first grooves 25.

The moth-eye structures 23 include multiple nanoscale protrusions to enhance light transmittance. The support structures 24 connect the moth-eye structures 23 to the second region 102. The first grooves 25 are formed between the moth-eye structures 23 and the second region 102. The support structures 24 and the first grooves 25 are located on opposite sides of the moth-eye structures 23 along the extending direction A.

In Block S3, by setting the second photosensitive layer 22 on the first photosensitive layer 21, the adjustment of the etching depth is achieved by utilizing the Loading Effect. The Loading Effect refers to that the etching depth in the densely patterned area (that is, the first holes 221 and the corresponding multiple first openings 211) is less than that in the sparsely patterned area (that is, the second holes 222 and the corresponding third openings 212). The wide pattern (that is, the second holes 222 and the corresponding third openings 212) is etched deeply, and the narrow pattern (that is, the first opening 211) is etched shallowly. This is because in the dense patterned area or the narrow pattern, the substrate 10 is etched and removed slowly, while in the sparsely patterned area or the wide pattern, the substrate may be etched and removed more quickly. In block S3, the moth-eye structure 23, the support structure 24, and the first trench 25 are all formed by inductively coupled plasma (ICP) etching.

Block S4, referring to FIG. 4, the first photoresist 20 is removed to obtain a first intermediate structure 26. The first intermediate structure 26 includes the moth-eye structures 23 and the support structures 24. The support structures 24 connect the moth-eye structures 23 to the second region 102. The first intermediate structure 26 defines the first grooves 25. The first grooves 25 is formed between the moth-eye structures 23 and the second region 102.

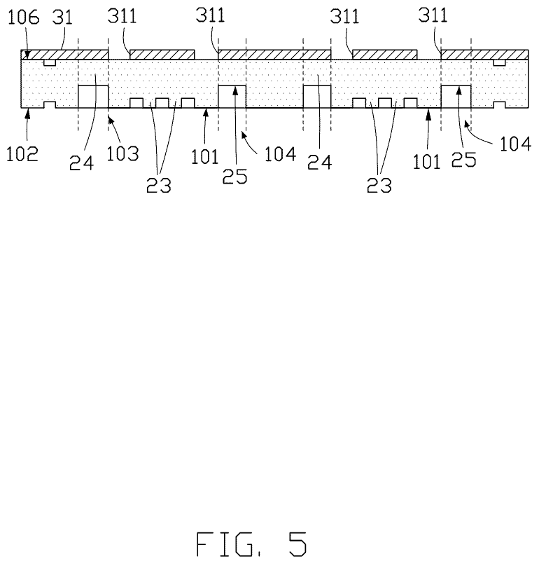

Block S5, referring to FIGS. 5 to 7, a light-blocking element 30 is disposed on the second surface 106 of the first intermediate structure 26. The light-blocking element 30 is provided with a light-transmitting hole 33, which exposing the central area of the first region 101.

In this embodiment, the light-blocking element 30 is made of metallic chromium and formed by selectively sputtering. The disposing of the light-blocking element 30 may be carried out by the followings steps.

Referring to FIG. 5, a light-blocking pattern 31 is provided on the second surface 106. The light-blocking pattern 31 has a slot 311 for exposing a portion of the second surface 106.

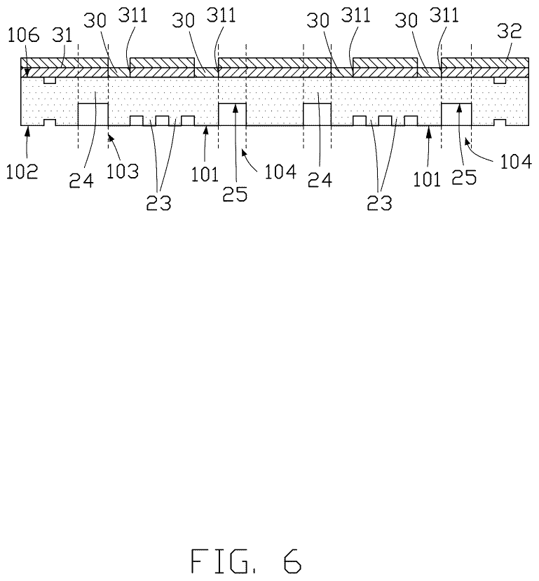

Referring to FIG. 6, a light-blocking layer 32 is formed on the light-blocking pattern 31 by sputtering, and the light blocking layer 32 fills a portion of the slot 311 to form the light-blocking element 30.

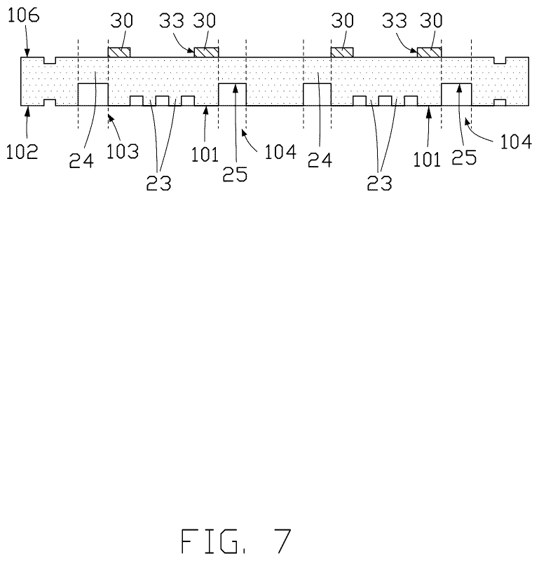

Referring to FIG. 7, the light-blocking pattern 31 and the corresponding portion of the light-blocking layer 32 are removed to leave the light-blocking element 30 on the second surface 106.

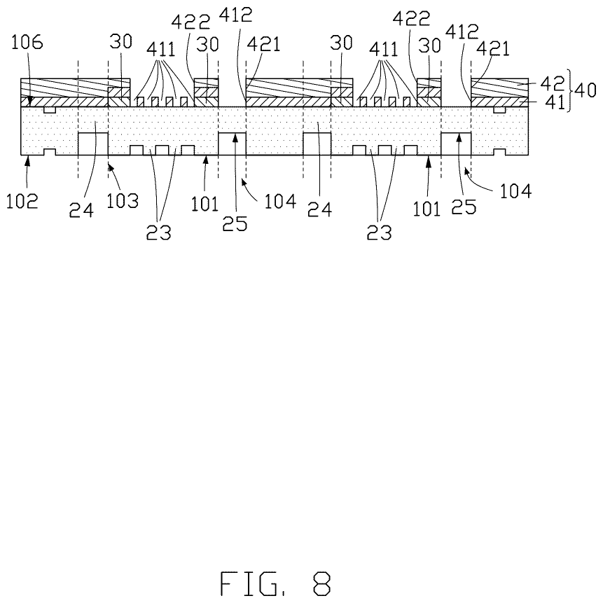

Block S6, referring to FIG. 8, a second photoresist 40 is formed on the second surface 106 of the substrate 10. The second photoresist 40 covers the light-blocking element 30. The second photoresist 40 includes a third photoresist layer 41 and a fourth photoresist layer 42. A portion of the third photoresist layer 41 is disposed between the fourth photoresist layer 42 and the second surface 106, and another portion of the third photoresist layer 41 is disposed between the fourth photoresist layer 42 and the light-blocking element 30. The second photoresist 40 is a negative photoresist, which is insoluble in the developer solution after exposure to light.

The third photoresist layer 41 has multiple second openings 411 and multiple fourth openings 412. The second openings 411 face the first region 101. The fourth openings 412 face the fourth region 104, and a portion of the second surface 106 is exposed from the second openings 411 and the fourth openings 412. The cross-sectional width of the second opening 411 is at the nanoscale, that is, the cross-sectional width of the second opening 411 is between 1 nanometer and 999 nanometers. The cross-sectional width of the fourth opening 412 is at the millimeter scale, that is, the cross-sectional width of the fourth opening 412 is between 1 millimeter and 999 millimeters.

The fourth photoresist layer 42 has a first through-hole 421 and a second through-hole 422. The first through-hole 421 connects to the fourth openings 412 in the fourth region 104. The second through-hole 422 connects to the second openings 411 in the first region 101.

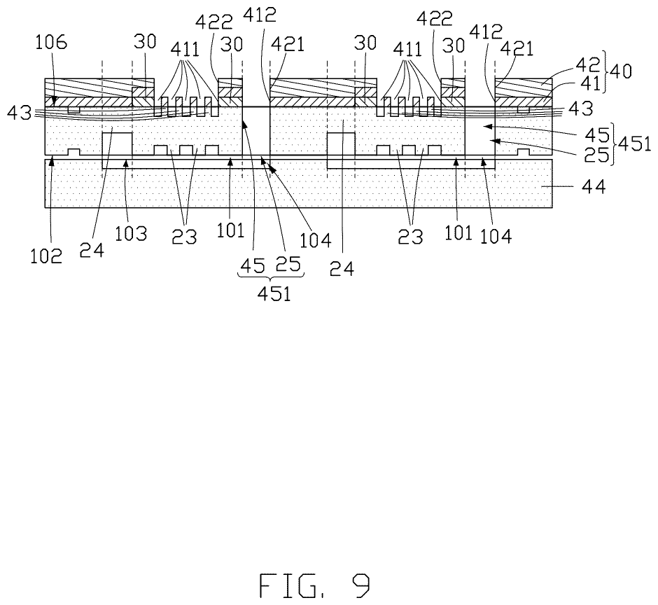

Block S7, referring to FIG. 9, the exposed portion of the first region 101 is etched through the second openings 411 and the second through-hole 422 to form metasurface lenses 43. The metasurface lenses 43 are exposed through the light-transmitting hole 33. The metasurface lenses 43 includes multiple nanoscale protrusions 431. The nanoscale protrusions 431 are opposite to the moth-eye structures 23.

In this embodiment, a cooling baffle 44 is further provided on the first surface 105 of the substrate 10. The cooling baffle 44 is used to prevent instant etching through the substrate 10, and causes the helium cooling gas to in contact with the ICP etching gas.

Then, the exposed portion of the fourth region 104 is etched through the fourth openings 412 and the first through-hole 421 to form second grooves 45. The second grooves 45 connect to the first grooves 25 to form hollow regions 451. The hollow regions 451 is located between the metasurface lenses 43 and the second region 102.

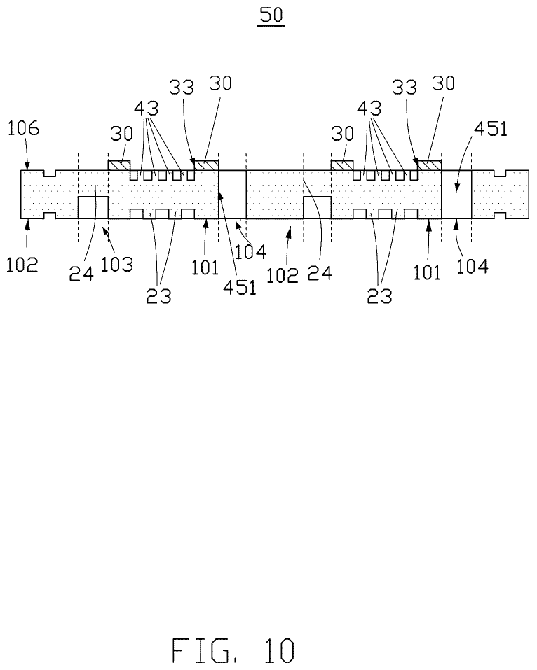

Block S8, referring to FIG. 10, the second photoresist 40 and the cooling baffle 44 are removed to obtain a second intermediate structure 50. The second intermediate structure 50 includes the second region 102, the support structures 24, multiple metasurface lenses 43, and multiple moth-eye structures 23. Each metasurface lens 43 corresponds to one moth-eye structure 23. The support structures 24 connect the metasurface lenses 43 to the second region 102. The second intermediate structure 50 has the hollow regions 451 between the metasurface lenses 43 and the second region 102.

In this embodiment, the second photoresist 40 is removed by a lift-off process. The lift-off process involves depositing a sacrificial layer over the second photoresist 40, patterning the sacrificial layer to cover only the desired nanoscale structures, and then dissolving the second photoresist 40 along with the unwanted material, ensuring that only the desired nanoscale structures remain on the substrate 10.

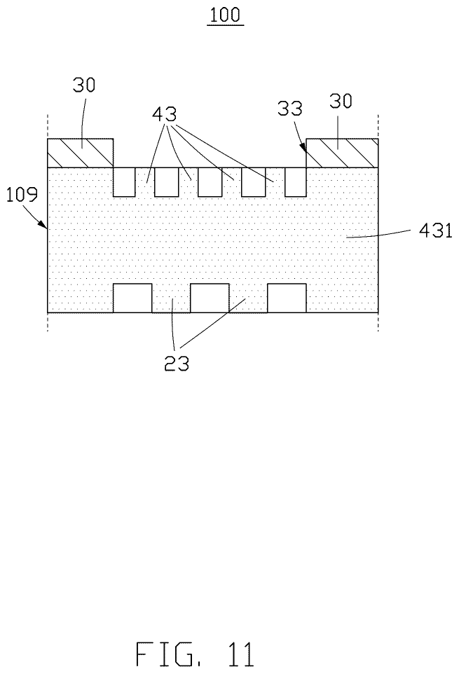

Block S9, referring to FIG. 11, the support structures 24 are cutted to separate the metasurface lenses 43 from the second region 102, thereby obtaining multiple metasurface lens assemblies 100.

The method provided in the present application ultizing the support structure 24 to enhances the structural strength of the nanoscale protrusions 431 of the metasurface lenses 43, reducing the risk of any damage during the cutting processes in block S9. The method achieves “painless” cutting of the metasurface lens assembly 100. Furthermore, there is no need for a protective support layer before the metasurface lenses 43 from the second region 102, thereby simplifying the manufacturing process.

Referring to FIG. 11, an embodiment of the present application also provides a metasurface lens assembly 100. The metasurface lens assembly 100 can be applied to advanced imaging systems, sensors, and communication devices. The metasurface lens assembly 100 includes a body 109, a metasurface lens 43 disposed on one side of the body 109, a moth-eye structure 23 disposed on the other side of the body 109, and a light-blocking element 30 disposed around the metasurface lens 43. The metasurface lens 43 includes multiple nanoscale protrusions 431 to refract the light passing through, thereby achieving specific optical effects such as focal length adjustment or image processing. The moth-eye structure 23 mimics the microstructure of moth eyes in nature, effectively reducing surface reflection and increasing the transmittance of the metasurface lens assembly 100. The light-blocking element 30 is used to block stray light, helping to reduce image blurring or contrast reduction, ensuring clear imaging effects.

Even though information and advantages of the present embodiments have been set forth in the foregoing description, together with details of the structures and functions of the present embodiments, the disclosure is illustrative only. Changes may be made in detail, especially in matters of shape, size, and arrangement of portion within the principles of the present exemplary embodiments, to the full extent indicated by the plain meaning of the terms in which the appended claims are expressed.

What is claimed is:

1. A method for manufacturing a metasurface lens assembly, comprising:
providing a substrate comprising a first region, a second region, and a third region connecting the first and second regions;
etching the third region to form support structures which are micron-sized;
etching one side of the first region to form metasurface lenses connected to the support structures, the metasurface lenses are nanosized; and
removing the support structures to separate the metasurface lenses from the second region, thereby obtaining the metasurface lens assembly.

2. The method of claim 1, wherein the support structures and the metasurface lenses are respectively located on two surfaces of the substrate, wherein etching the third region to form the support structures comprises:
forming a first photoresist on one of the two surfaces of the substrate, the first photoresist having openings corresponding to the third region to expose a portion of the third region;
etching the exposed portion of the third region to form the support structures; and
removing the first photoresist.

3. The method of claim 2, wherein etching one side of the first region to form the metasurface lenses comprises:
forming a second photoresist on another of the two surfaces of the substrate, the second photoresist having openings corresponding to the first region to expose a portion of the first region;
etching the exposed portion of the first region to form the metasurface lenses; and
removing the second photoresist.

4. The method of claim 3, wherein the substrate further comprises a fourth region connecting the first and second regions, wherein etching the third region to form the support structures further comprises:
removing a portion of the fourth region to form a first groove, and
etching one side of the first region to form the metasurface lenses further comprises:
removing another portion of the fourth region to form a second groove, and the first groove connecting the second groove to form a hollow region.

5. The method of claim 4, wherein the first photoresist has openings corresponding to the first region to expose a portion of the first region, the method further comprising:
etching the exposed portion of the first region through the openings to form moth-eye structures, and the moth-eye structures being opposite to the metasurface lenses.

6. The method of claim 4, wherein the first photoresist comprises a first photoresist layer and a second photoresist layer, the first photoresist layer is disposed between the second photoresist layer and one side of the substrate, forming the first photoresist on one of the two surfaces of the substrate comprises:
forming the first photoresist layer on the one of the two surfaces of the substrate, the first photoresist layer having openings corresponding to the first region and the third region to expose a portion of the first region and the third region;
forming the second photoresist layer on the first photoresist layer, the second photoresist layer having through-holes corresponding to the first region and the third region, and each of the through-holes corresponding to one of the openings.

7. The method of claim 4, wherein the second photoresist comprises a third photoresist layer and a fourth photoresist layer, the third photoresist layer is provided between the fourth photoresist layer and the other side of the substrate, forming the second photoresist on another of the two surfaces of the substrate comprises:
forming the third photoresist layer on the another one of the two surfaces of the substrate, and the third photoresist layer having openings corresponding to the first region and the fourth region;
forming the fourth photoresist layer on the third photoresist layer, the fourth photoresist layer having through-holes corresponding to the first region and the fourth region, and each of the through-holes corresponding to one of the two openings.

8. The method of claim 7, wherein before providing the third photoresist layer on the another of the two surfaces of the substrate, the method further comprising:
forming a light-blocking element on the another of the two surfaces of the substrate, the light-blocking element having a light-transmitting hole for exposing the metasurface lens.

9. The method of claim 7, wherein:
the first photoresist is a positive photoresist and the second photoresist is a negative photoresist.

10. The method of claim 1, wherein the substrate is pre-treated with a plasma cleaning process before etching the third region.

11. The method of claim 1, wherein the third region is etched by a inductively coupled plasma etching process to form the support structures; the first region is etched by the inductively coupled plasma etching process to form the metasurface lenses.

12. A metasurface lens assembly, comprising:
a body;
a metasurface lens arranged on one side of the body, the metasurface lens comprising multiple nanoscale protrusions, and the nanoscale protrusions being configured to refract light; and
a moth-eye structure arranged on the other side of the body, and the moth-eye structure being configured to enhance light transmittance of the metasurface lens.

13. The metasurface lens assembly of claim 12, further comprising a light-blocking element, wherein the light-blocking element is disposed on one side of the body, the light-blocking element defines a light-transmitting hole, and the metasurface lens is exposed to the light-transmitting hole.

14. The metasurface lens assembly of claim 12, wherein the metasurface lens is made of one of silicon, gold, silver, and aluminum.
